(19) United States
(12) Patent Application Publication
(10) Pub. No.: US 2026/0184055 A1
(43) Pub. Date: Jul. 2, 2026

(54) MULTILAYER DEEP-DRAWABLE PACKAGING MATERIAL

(71) Applicant: Felix Schoeller GmbH & Co. KG, Osnabrück (DE)

(72) Inventor: Andreas FEHLKER, Osnabrück (DE)

(21) Appl. No.: 18/857,146

(22) PCT Filed: Apr. 20, 2023
(86) PCT No.: PCT/EP2023/060237

§ 371 Date: Oct. 15, 2024

(30) Foreign Application Priority Data
Apr. 20, 2022 (EP) 22169077.9

(51) Int. Cl. B32B 29/00; B32B 7/12; B32B 37/12; B32B 38/00

(52) U.S. Cl. CPC B32B 29/005; B32B 7/12; B32B 37/1284; B32B 38/145; B32B 2250/02; B32B 2250/26; B32B 2255/12; B32B 2255/26; B32B 2307/51; B32B 2307/7166; B32B 2307/718; B32B 2307/7244; B32B 2307/7246; B32B 2329/04; B32B 2553/00

(57) ABSTRACT

The invention relates to a multilayer deep-drawable packaging material having an upper face and a lower face, comprising at least one first and one second paper layer and at least one polymer layer, wherein the at least one first and one second paper layer are connected to one another by the at least one polymer layer, wherein the at least one polymer layer contains at least one water-soluble thermoplastic polymer. The invention also relates to a method for producing a multilayer deep-drawable packaging material, comprising the following steps: (a) providing a first paper layer; (b) applying a polymer layer to the first paper layer; (c) connecting the first paper layer, with the polymer layer applied thereto, to a second paper layer such that the polymer layer is located between the first paper layer and the second paper layer; or (a′) providing a second paper layer; (b′) applying a polymer layer to the second paper layer; (c′) connecting the second paper layer, with the polymer layer applied thereto, to a first paper layer such that the polymer layer is located between the first paper layer and the second paper layer, wherein the polymer layer in step (b) contains at least one water-soluble and thermoplastic polymer. The invention also relates to the use of the multilayer deep-drawable packaging material according to the invention for producing packaging, in particular food packaging.

The invention relates to a multilayer deep-drawable packaging material, to a method for producing the packaging material, and to the use of the packaging material for producing packaging, in particular food packaging.

In the field of web-type packaging materials, paper-based products are used for many applications. Frequently, and when there are low requirements for the barrier properties of the packaging material, this is done without further modifications, such as the application of synthetic polymer coatings or synthetic polymer films.

Synthetic polymer coatings are used to give packaging papers barrier properties against oxygen, water vapor, oil, grease and other substances. The requirements that the food industry in particular places on such packaging materials are very high, especially for sensitive products, and have so far usually been met by incorporating synthetic polymer coatings, polymer films or aluminum foils into the multilayer packaging material.

The societal development of the past few years has led to an increasing rethinking in the field of packaging materials. One of the market's demands on packaging material manufacturers is to use more environmentally friendly and more highly recyclable materials based on paper and renewable raw materials wherever possible. A major challenge for food packaging manufacturers is to achieve the required high barrier properties and at the same time provide a particularly environmentally friendly and recyclable packaging material.

This also applies, in particular, to packaging materials that are shaped using deep-drawing processes due to the requirements regarding the shape of the packaging material. Such deep-drawable packaging materials are described, for example, in EP 2 586 606 A1 and are usually composed of at least two paper layers connected by a layer of a thermoplastic water-insoluble polymer. The packaging material is deep-drawn under the influence of pressure and temperature, and the thermoplastic, water-insoluble polymer ensures that the shape is retained after cooling. For example, after the application of an additional barrier layer made of a likewise water-insoluble synthetic polymer, inter alia trays and plates for cold cuts and other foods can be produced.

A disadvantage of these deep-drawable packaging materials is that at least one of the basically water-soluble paper layers in the multilayer deep-drawable packaging material lies between two synthetic water-insoluble polymer layers. This makes recycling the packaging material after use very complex, so that recycling the packaging material is practically only possible at high cost and is therefore uneconomical. As a result, recycling of a deep-drawable packaging material of this kind hardly ever takes place in practice.

Solution approaches known in the prior art that are intended to allow the synthetic polymer layer to be removed via a punched edge at the borders of the packaging material have proven to be unsuitable for practical use. In addition, although these theoretically allow the separation of the multilayer deep-drawable packaging material, the fundamental use of synthetic water-insoluble polymers in the packaging material cannot be dispensed with. Furthermore, a deep-drawable packaging material of this kind cannot be easily recycled or composted, despite the individual components being separable.

Against the background of the prior art, the object of the invention was to provide a multilayer deep-drawable packaging material which does not have the disadvantages of the prior art and in particular achieves the required high barrier properties for use as food packaging and at the same time can be easily recycled and, if necessary, composted.

This object was achieved by a multilayer deep-drawable packaging material having an upper face and a lower face, comprising at least one first and one second paper layer and at least one polymer layer, wherein the first and second paper layer are connected to one another by the at least one polymer layer, characterized in that the at least one polymer layer contains at least one water-soluble thermoplastic polymer.

It has surprisingly been found that the use of a water-soluble thermoplastic polymer in the at least one polymer layer connecting the first and second paper layer results in a deep-drawable packaging material which achieves the high stability required for use as food packaging and at the same time is easy to recycle due to the water solubility of the thermoplastic polymer used. In particular, the polymer layer can be completely dissolved by water and the two paper layers can thus be easily separated from the polymer layer and recycled.

The packaging material according to the invention has an upper face and a lower face.

The “upper face” of the packaging material according to the invention is the face which, in later usage, has contact with the product to be packaged, for example a food item. The upper face of the packaging material according to the invention is formed by the at least one first paper layer.

The “lower face” of the packaging material according to the invention is the face opposite the upper face of the packaging material according to the invention. The lower face of the packaging material according to the invention is formed by the at least one second paper layer and, in later usage, is the outside of the packaging. The lower face can be equipped for printing if necessary.

The multilayer deep-drawable packaging material according to the invention comprises at least one first and one second paper layer. According to the invention, the term “paper layer” is understood to mean a layer made of paper.

Paper, in the sense of the invention, is either a base paper or a coated base paper. Here, the term “base paper” refers to uncoated or surface-sized paper. A base paper may contain, in addition to pulp fibers, sizing agents such as alkyl ketene dimers, fatty acids and/or fatty acid salts, epoxidized fatty acid amides, alkenyl or alkyl succinic anhydride, wet strength agents such as polyamine-polyamide-epichlorohydrin, dry strength agents such as anionic, cationic or amphoteric polyamides or cationic starches, optical brighteners, fillers, pigments, dyes, defoamers, and other auxiliaries known in the paper industry.

The base paper can be surface-sized. Suitable sizing agents for this purpose are, for example, polyvinyl alcohol or oxidized starch. The base paper can be produced on a Fourdrinier or a Yankee paper machine (cylinder paper machine). The basis weight of the base paper is preferably 30 to 300 g/m², in particular 60 to 250 g/m², particularly preferably 100 to 220 g/m². The base paper can be used in uncompacted or compacted form (smoothed). Base papers having a density of 0.8 to 1.2 g/cm³, preferably 0.90 to 1.1 g/cm³, are particularly suitable.

For example, bleached hardwood kraft pulp (BHKP), bleached softwood kraft pulp (BSKP), bleached hardwood sulfite pulp (BHSP) or bleached softwood sulfite pulp (BSSP) can be used as pulp fibers. Pulp fibers obtained from paper waste can also be used. The mentioned pulp fibers can also be used as a mixture and may contain proportions of other fibers, for example synthetic resin fibers. However, pulp fibers made from 100% hardwood pulp are preferably used. The average fiber length of the unmilled pulp is preferably 0.6 mm to 0.85 mm (Kajaani measurement). Furthermore, the pulp preferably has a lignin content of less than 0.05 wt. %, in particular 0.01 to 0.03 wt. %, relative to the mass of the pulp. Fillers used in the base paper can be, for example, kaolins, calcium carbonate in its natural forms such as limestone, marble or dolomite stone, precipitated calcium carbonate, calcium sulfate, barium sulfate, titanium dioxide, talc, silica, aluminum oxide, and mixtures thereof.

In another embodiment of the invention, the paper layer may consist of a coated base paper. In the case of a coated base paper, at least one pigment-containing layer is disposed on at least one side of the base paper. Pigments used can be a metal oxide, silicate, carbonate, sulfide or sulfate. Pigments such as kaolins, talc, calcium carbonate and/or barium sulfate are particularly suitable.

In another embodiment of the invention, a pigment mixture consisting of the above-mentioned calcium carbonate and kaolin can be used for the pigment-containing layer. The ratio of calcium carbonate to kaolin is preferably 30:70 to 70:30. The ratio of binder to pigment in the pigment-containing layer can be 0.1 to 2.5, preferably 0.2 to 1.5, but in particular approximately 0.9 to 1.3.

Any known water-soluble and/or water-dispersible binder can be used in the pigment-containing layer. In addition to latex binders, film-forming starches such as thermally modified starches, in particular corn starches or hydroxypropylated starches, are particularly suitable for this purpose. The pigment-containing layer can be applied inline or offline using all application units commonly used in paper production, and the application amount is preferably selected such that after drying the application weight is 0.1 to 30 g/m², in particular 1 to 20 g/m², or according to a particularly preferred embodiment 2 to 8 g/m².

In a preferred embodiment, the pigment-containing layer is applied using a size press or film press integrated within the paper machine. The paper layer is substantially based on renewable raw materials, such as cellulose and cellulose derivatives.

The paper and thus the paper layer can have a basis weight of 30 to 300 g/m², in particular of 60 to 250 g/m², particularly preferably of 100 to 220 g/m².

According to a preferred embodiment of the invention, the at least one first paper layer and the at least one second paper layer are uncoated base papers.

According to an alternative preferred embodiment of the invention, the at least one first paper layer is an uncoated base paper and the at least one second paper layer is a coated base paper.

According to another alternative preferred embodiment of the invention, the at least one first paper layer and the at least one second paper layer are coated base papers.

The packaging material according to the invention comprises at least one polymer layer, wherein the first and the second paper layer are connected to one another by the at least one polymer layer, i.e., the at least one polymer layer is located, in the packaging material according to the invention, between the first and the second paper layer and has contact, preferably full-surface contact, with the first and second paper layer.

The at least one polymer layer contains at least one water-soluble thermoplastic polymer. The at least one polymer layer can also comprise a mixture of water-soluble thermoplastic polymers.

“Water-soluble,” in the sense of the invention, means that at least 25% (m/m) of polymer is clearly soluble in water, so that no clouding is visually detectable. In particular, the water-soluble polymers have, in the pH range from 3 to 11, a water solubility of at least 35% (m/m), particularly preferably at least 55% (m/m), in particular at least 65% (m/m), very particularly preferably at least 75% (m/m), in particular 100% (m/m). All water solubility specifications for all water-soluble thermoplastic polymers used according to the invention relate to standard conditions of 20±5° C. and standard air pressure of 1013.25 hPa. The specification (m/m) means mass fraction of polymer relative to mass fraction of water.

A thermoplastic polymer is a linear or branched polymer which has no chemical crosslinking points, i.e., covalent bonds, between individual polymer chains.

A thermoplastic polymer becomes flowable in principle above the glass transition temperature (Tg) in the case of an amorphous thermoplastic polymer, or above the melting temperature (Tm) in the case of a (partially) crystalline thermoplastic polymer. A thermoplastic polymer can therefore be processed into molded parts in its softened state by pressing, extruding, injection molding or other forming processes.

A distinction of a thermoplastic polymer (thermoplastics) with respect to the other two large polymer classes, elastomers and thermosets, both of which have chemical crosslinking points, i.e., covalent bonds, between individual polymer chains, can, as a person skilled in the art knows, be made on the basis of the different temperature curve of the shear modulus G (also known as modulus of rigidity G). The determination of the shear modulus G according to temperature can be carried out by means of conventional methods known to a person skilled in the art, for example by means of dynamic mechanical thermal analysis (DMTA).

The proportion of the water-soluble thermoplastic polymer in the at least one polymer layer is preferably at least 90 wt. %, particularly preferably at least 95 wt. %, very particularly preferably 98 wt. %, in particular 99 wt. %, relative to the total weight of the polymer layer (absolutely dry). According to a particularly preferred embodiment of the invention, the polymer layer consists of the water-soluble thermoplastic polymer.

In addition to the water-soluble thermoplastic polymer, the at least one polymer layer can contain up to 10 wt. %, preferably up to 5 wt. %, preferably up to 2 wt. %, particularly preferably up to 1 wt. %, very particularly preferably 0 wt. %, of further constituents, relative to the total weight of the polymer layer (absolutely dry). Other constituents may be common additives that are added to the thermoplastic polymers to improve processability.

According to a preferred embodiment of the invention, the at least one water-soluble and thermoplastic polymer has a modulus of elasticity of at least 0.3 GPa, preferably 0.5 GPa, particularly preferably 0.8 GPa. The modulus of elasticity is related to the shear modulus G and is determined by means of tensile testing with the Lorentzen & Wettre Tensile Tester, as described below in connection with the examples. It has been found that the deep-drawability of the packaging material according to the invention is improved if its polymer layer contains at least one water-soluble thermoplastic polymer which has the above-mentioned modulus of elasticity.

According to a further preferred embodiment of the invention, the at least one water-soluble and thermoplastic polymer is a biopolymer or a mixture of biopolymers, in particular a biopolymer selected from modified and natural biopolymers and mixtures thereof. As used herein, the term “biopolymer” is understood to mean a polymer which has been produced from renewable raw materials (natural biopolymer), occurs in nature as a polymer (natural biopolymer) or occurs in nature as a polymer and has been subsequently chemically and/or physically modified (modified biopolymer).

Preferably, the biopolymer is selected from the group consisting of polysaccharides, in particular thermoplastic starch (TPS), polylactides (PLAs), polyhydroxybutyrates (PHBs), lignin-based thermoplastic polymers, polyvinyl alcohols (PVOHs) and ethylene vinyl alcohol copolymers (EVOHs), based on renewable raw materials, for example cane sugar, and mixtures thereof.

The use of a biopolymer as a water-soluble thermoplastic polymer increases the recyclability of the packaging according to the invention and allows its compostability. Of course, these effects increase with increasing proportion of the biopolymer in the at least one water-soluble thermoplastic polymer.

According to a particularly preferred embodiment of the invention, the proportion of synthetic polymers in the packaging material is less than 20 wt. %, preferably less than 10 wt. %, particularly preferably less than 5 wt. %, relative to the total weight of the packaging material (absolutely dry). Synthetic polymers include both water-soluble thermoplastic polymers based on mineral oil, which are not biopolymers, and other conventional thermoplastic polymers based on mineral oil, which are predominantly not water-soluble.

The application weight (absolutely dry) of the at least one polymer layer in the packaging material according to the invention can be in the range from 1 to 50 g/m², in particular in the range from 10 to 30 g/m².

For some usages it may be desirable to improve the barrier properties of the packaging material according to the invention. This can be achieved in the packaging material according to the invention in that a functional layer is provided on the upper face of the packaging material, which, in later usage, has contact with the packaged product.

A functional layer can, for example, comprise or consist of a layer of a water-insoluble thermoplastic polymer, a water-insoluble thermoplastic polymer film or an aluminum foil.

To improve the barrier properties of the packaging material according to the invention, it has proven particularly practical if the functional layer comprises or consists of a layer made of a water-insoluble thermoplastic polymer or made of a water-insoluble thermoplastic polymer film. Preferably, the water-insoluble synthetic polymer or the water-insoluble synthetic polymer film is selected from the group consisting of PE, PP, PVOH, EVOH, PLA and mixtures thereof. The provision of a functional layer is advantageous in particular when the goods to be packaged, e.g., a food item, is moist, in order to prevent the moisture from penetrating the packaging material and thus causing it to soften. According to a preferred embodiment of the invention, the water-insoluble thermoplastic polymer for the functional layer consists of PE and/or EVOH from renewable raw materials, for example sugar cane. This is advantageous because the use of fossil raw materials can be avoided.

“Water-insoluble” in the sense of the invention means that, at 25° C., the water-insoluble thermoplastic polymer has a water solubility of at most 2% (m/m), particularly preferably 0% (m/m), in water.

According to a particularly preferred embodiment of the invention, the oxygen permeation of the packaging material is not more than 15 cm³/m² in 24 hours, measured according to DIN 53380-3 at a temperature of 23° C., 50% relative humidity and an air pressure of 1 atm. This advantageously leads to an extended shelf life of a good, e.g., a food item, to be packaged by means of the packaging material according to the invention.

According to another particularly preferred embodiment of the invention, the water vapor permeation of the packaging material is not more than 50 g/m² in 24 hours, measured according to EN ISO 15106-3 at a temperature of 23° C., 50% relative humidity and an air pressure of 1 atm. It has been found that this embodiment of the packaging material according to the invention protects moist goods to be packaged, e.g., a moist food item, from drying out and, on the other hand, protects dry goods to be packaged, e.g., a dry food item, from moisture. Overall, this results in an extended shelf life of the goods to be packaged.

The packaging material according to the invention preferably has a basis weight of 150 to 600 g/m², in particular from 300 to 500 g/m², on. Such a basis weight ensures that the packaging material is sufficiently stable against impacts, so that the occurrence of holes in the packaging, which could affect the shelf life of the goods packaged therein, can be avoided during everyday handling.

The multilayer deep-drawable packaging material according to the invention has a recyclability of more than 13 scoring points (limited), preferably more than 16 scoring points (good), determined according to the assessment of recyclability specified below, in accordance with the method described in project number 530592 of the bifa Umweltinstitut with the project title “Recyclingfähigkeit von Verpackungen” (bifa Umweltinstitut (2019): Recyclingfähigkeit von Verpackungen. Konkretisierung Untersuchungsrahmen und Kriterienkatalog. With the collaboration of Tschachtli S., Pitschke T., Kreibe S., Martin A. Published by INTERSEROH Dienstleistungs GmbH. Augsburg; available online at: https://www.interseroh.de/fileadmin/Verpackungsoptimierung/530592_Recycli ngfaehigkeit_Bewertungskatalog_v6_3_Download.pdf, checked on 30 Mar. 2020).

The invention also relates to a method for producing a multilayer deep-drawable packaging material, comprising the following steps:
(a) providing a first paper layer;
(b) applying a polymer layer to the first paper layer;
(c) connecting the first paper layer, with the polymer layer applied thereto, to a second paper layer such that the polymer layer is located between the first paper layer and the second paper layer, or
(a′) providing a second paper layer;
(b′) applying a polymer layer to the second paper layer;
(c′) connecting the second paper layer, with the polymer layer applied thereto, to a first paper layer such that the polymer layer is located between the first paper layer and the second paper layer,
wherein the polymer layer in step (b) and step (b′) contains at least one water-soluble thermoplastic polymer.

For the features described in connection with the method according to the invention, what was said for the same features which were already described above in connection with the packaging material according to the invention applies accordingly.

According to the method according to the invention for producing a multilayer deep-drawable packaging material, a first paper layer is provided in step (a) or a second paper layer is provided in step (a′). The first paper layer or second paper layer can be designed in such a way as has already been explained in detail in connection with the packaging material according to the invention. Providing may include, for example, producing the paper in a paper machine and feeding the paper into an extrusion coating system. After completion, the paper is rolled up in the reel section of the paper machine, and the paper roll is transported to the extrusion coating system, clamped in the extrusion coating system and continuously unrolled.

According to the method according to the invention, a polymer layer is applied to the first paper layer in step (b) or a polymer layer is applied to the second paper layer in step (b′), wherein the polymer layer in step (b) and step (b′) contains at least one water-soluble thermoplastic polymer. What has already been said above in connection with the packaging material according to the invention applies to the design(s) of the polymer layer and of the water-soluble thermoplastic polymer. The polymer layer can be applied in an extrusion coating system by extrusion or co-extrusion.

Step (c) of the method according to the invention provides for connecting the first paper layer, with the polymer layer applied thereto, to a second paper layer such that the polymer layer is located between the first paper layer and the second paper layer. Step (c′) of the method according to the invention provides for connecting the second paper layer, with the polymer layer applied thereto, to a first paper layer such that the polymer layer is located between the first paper layer and the second paper layer. The connecting of the first paper layer and the second paper layer according to step (c) or (c′) can take place simultaneously or after the application of the polymer layer according to step (b) or (b′).

According to a preferred embodiment of the invention, before or after step (a) or during or after step (b) or after step (c) or before or during step (c′) a functional layer is applied to the upper face of the first paper layer, which, in later usage, has contact with the product to be packaged. The functional layers mentioned above in connection with the packaging material according to the invention can be used as this functional layer. According to a particularly preferred embodiment, a layer made of a water-insoluble thermoplastic polymer or of a water-insoluble thermoplastic polymer film is used as the functional layer. The functional layer can be applied using the usual methods known to a person skilled in the art. The functional layer is preferably applied by (co-)extrusion or curtain coating. It has proven to be particularly practical to apply the functional layer by means of curtain coating.

Before or after step (c) or before step (a′) or after step (c′), printing can be carried out on the lower face of the second paper layer, which, in later usage, forms the visible face of the packaging. If a functional layer is present on the upper face of the first paper layer, printing on the lower face of the second paper layer is preferably carried out after the functional layer has been applied.

Finally, the invention also relates to the use of the multilayer deep-drawable packaging material according to the invention for producing packaging, in particular food packaging.

The invention is further explained below with reference to the following figures and examples.

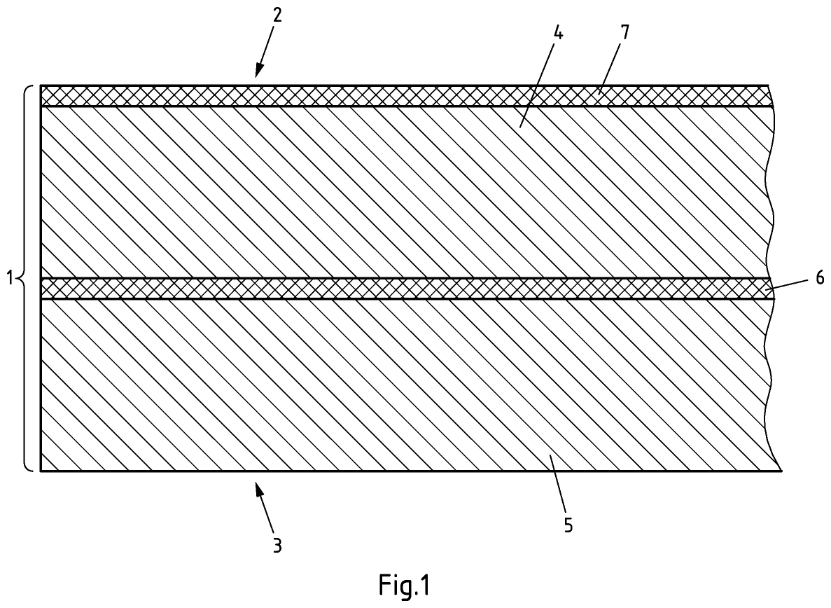

FIG. 1 is a schematic representation of an embodiment of the multilayer deep-drawable packaging material according to the invention.

FIG. 1 shows schematically an embodiment of the multilayer deep-drawable packaging material 1 according to the invention. The packaging material 1 according to the invention has an upper face 2 and a lower face 3 and comprises a first paper layer 4, a second paper layer 5 and a polymer layer 6. In later usage, the upper face 2 is in contact with the product to be packaged, for example a food item. The lower face 3 is the visible face of the packaging material in later usage and can be provided with a print. The first paper layer 4 and the second paper layer 5 have, for example, a basis weight between 30 and 300 g/m². The first paper layer 4 and the second paper layer 5 are connected to one another by the polymer layer 6. The polymer layer has, for example, an application weight (absolutely dry) of 1 to 50 g/m². The polymer layer 6 contains or consists of a water-soluble thermoplastic polymer, in particular a biopolymer. The first paper layer 4 has a functional layer 7 on the upper face. The functional layer 7 has, for example, an application weight (absolutely dry) of 1 to 50 g/m² and contains or consists of a water-insoluble thermoplastic polymer, in particular PE, PP, PVOH, EVOH, PLA and mixtures thereof.

### EXAMPLE

The product FibreForm 200 from BillerudKorsnäs, having a basis weight of 200 g/m², is used as food-safe base paper.

To produce a packaging material according to the invention, the two food-safe base paper webs are connected by means of a polymer layer of a water-soluble thermoplastic polymer, in this example a polyvinyl alcohol (Mowiflex C 30 from Kuraray), by extrusion in an extrusion coating system. The application weight of the polyvinyl alcohol layer is 10 g/m².

In the next step, a polyethylene layer is applied as a functional layer to the upper face of the resulting composite material by extrusion. The application weight of the polyethylene layer is 10 g/m².

The composite material with the extrusion-coated upper face is then led over a special smooth cooling cylinder. The finished cooled multilayer packaging material is removed from the extrusion coating system.

The result is a multilayer deep-drawable packaging material having good barrier properties in contact with foods, said packaging material being easy to recycle. In particular, the packaging material has a recyclability of at least 16 scoring points, determined according to the assessment of recyclability presented below, in accordance with the method described in project 530592 of the bifa Umweltinstitut with the project title “Recyclingfähigkeit von Verpackungen.”

### Methods and Standards

### Oxygen Permeation or Oxygen Transmission Rate (OTR)

The test is used to determine the oxygen transmission rate (permeation of pure oxygen or from oxygen gas mixtures, e.g., air) of plastics films and plastic hollow bodies (e.g., packaging containers, plastics pipes, etc.) and thus to assess their suitability for packaging purposes and for technical applications. The test is carried out according to DIN 53380-3 and at a temperature of 23° C. and a relative humidity of 50%.

### Water Vapor Permeation or Water Vapor Transmission Rate (WVTR)

The test is used to determine the water vapor transmission rate of plastics films, plastics webs (plates) and multilayer structures having a plastics portion using an electrolysis sensor. The test is carried out according to EN ISO 15106-3.

### Basis Weight

The basis weight was determined according to DIN EN ISO 536.

### Assessment of Recyclability

The examination is carried out according to the method described in project 530592 of the bifa Umweltinstitut with the project title “Recyclingfähigkeit von Verpackungen” for determining the recyclability of: paper, paperboard, cardboard packaging; paper, paperboard, cardboard composite; and liquid packaging board (bifa Umweltinstitut (2019): Recyclingfähigkeit von Verpackungen. Konkretisierung Untersuchungsrahmen und Kriterienkatalog. With the collaboration of Tschachtli S., Pitschke T., Kreibe S., Martin A. Published by INTERSEROH Dienstleistungs GmbH. Augsburg. Available online at: https://www.interseroh.de/fileadmin/Verpackungsoptimierung/530592_Recycli ngfaehigkeit_Bewertungskatalog_v6_3_Download.pdf, checked on 30 Mar. 2020).

“Recyclability,” in the sense of this test method, is understood to mean the property of a used or usable product made of paper, cardboard or paperboard to be able to be processed in a waste paper processing system compliant with the recognized technological standards, in such a way that the waste paper material produced allows the trouble-free and cost-efficient production of qualitatively acceptable new paper containing waste paper.

The criteria used to assess recyclability are:
Repulpability: Mass fraction of constituents that cannot be used for paper production, i.e., non-paper product constituents and residues of non-repulped fibrous material constituents. The determination of non-paper product constituents and repulpability is carried out according to PTS method PTS-RH 021/97, published by the Papiertechnische Stiftung.
Trouble-free sheet formation, i.e., no adhering contaminants or visual inhomogeneities, or cleanliness of the recycled mass fraction usable for paper production. The inspection for adhering contaminants or visual inhomogeneities is likewise carried out according to the PTS method PTS-RH 021/97.

Packaging materials are assigned to product category Il (see method for determining recyclability PTS-RH 021/97, published by the Papiertechnische Stiftung (PTS)). This comprises waste paper, which is mainly used for the production of packaging paper.

The quantitative assessment of the recyclability of a packaging is carried out using a scoring model based on scoring points. The starting point for the assessment are the criteria for assessing recyclability. The scoring model specifies a percentage weighting for the assessment criteria (see Table 1 below), this weighting being defined independently of the consideration of an individual packaging.

The quantitative assessment of recyclability is carried out in the following steps:
Based on the above-mentioned assessment criteria according to PTS-RH 021/97, the degree of fulfillment of the individual assessment criteria for the packaging to be examined can initially be qualitatively evaluated.
On the basis of the qualitative evaluation of the degree of fulfillment of the packaging to be examined, a graded quantitative assessment (rating) between 20 (best assessment—grade 1) and 0 or KO (worst assessment—grade 5) is carried out for each assessment criterion. The underlying scale is shown in Table 1 below.
By multiplying the criteria-specific assessment of the packaging with the corresponding weighting for the associated criterion, an individual score is obtained for each criterion.
The overall assessment of recyclability is obtained by summing all individual scores, with the following classification applying:

| | Percentage of | |
|---|---|---|
| | maximum number of | |
| | points (20) | |
| | represented by the | Classification of |
| Scoring points | lower limit | recyclability |
| ≥19 | 95% | Very good |
| <19 and >16 | 80% | Good |
| <16 and >13 | 65% | Limited |
| <13 and >10 | 50% | Considerably limited |
| <10 | <50% | Poor |
| KO assessment | | Not recyclable |
| in one criterion | | |

Further details on the method and the assessment criteria can be found in the indicated publications.

TABLE 1
Scoring model for quantitative assessment of recyclability

| | Scale (assessment in points) | | | | | |
|---|---|---|---|---|---|---|
| | Grade 1 | Grade 2 | Grade 3 | Grade 4 | Grade 5 | Grade 5 |
| Criterion | 20 | 15 | 10 | 5 | 0 | KO |

Level 1: Assignment of the packaging to the collection system

| | | | | | |
|---|---|---|---|---|---|
| Collection | Consumer can | Consumer can | — | Consumer can | Consumer cannot |
| system | assign collection | assign collection | | assign collection | assign collection |
| assignable | system intuitively | system intuitively | | system intuitively | system intuitively |
| | without problems | with limitation | | with difficulty | |

Level 2: Sortability of commingled packaging (lightweight packaging)

| | | | | | | |
|---|---|---|---|---|---|---|
| Minimum size | Packaging has a | — | — | Packaging does | — | — |
| | sufficient size | | | not have a | | |
| | (clearly >20 mm) | | | sufficient size | | |
| | | | | (clearly <20 mm) | | |
| Identifiability of | Detection of | Detection of | Detection of | — | Detection of | — |
| plastics material; | target material | target material | target material | | target material | |
| liquid packaging | possible without | limited | clearly limited | | not possible | |
| board; paper, | limitation, or | | | | | |
| paperboard, | special case of | | | | | |
| cardboard | flexible plastics | | | | | |
| composite; paper, | material | | | | | |
| paperboard, | | | | | | |
| cardboard; glass | | | | | | |
| (surface property) | | | | | | |

Level 3: Suitability for material recycling and provision of secondary products

| | | | | | | |
|---|---|---|---|---|---|---|
| High quality of | Expected recycling | Expected processing | Expected processing | | | Expected recycling |
| recycling path | path is high-quality | path is predom- | path is only | | | path of target |
| | material recycling | inantly high- | partially high- | | | material exclusively |
| | | quality material | quality material | | | energy recovery or - |
| | | recycling | recycling | | | only in isolated |
| | | | | | | cases - high- |
| | | | | | | quality material |
| | | | | | | recycling |
| Separable, non- | Packaging contains | Packaging contains | Packaging contains | Packaging contains | — | Packaging is |
| recyclable parts | no separable, | low fractions | significant fractions | considerable | | completely sep- |
| | non-recyclable | (<10% by mass) | (>10% by mass | fractions | | arated from the |
| | fractions | | and <30% by mass) | (>30% by mass) | | target fraction |
| Non-separable | Packaging bears | Packaging bears | Packaging bears | Packaging bears | Packaging bears | Packaging bears |
| fractions or | no undesirable | one or two | three or more | one or two | three (or more) | undesirable |
| contaminants | contaminants | different types | different types | different types | different types | contaminants |
| | | of contaminant | of contaminants | of contaminants | of contaminants | which preclude |
| | | with low | with low | with high | with high | recyclability |
| | | contamination risk | contamination risk | contamination | contamination | |
| | | | | risk | risk | |

### Elastic Modulus

The elastic modulus is determined according to the tensile strength test using the Lorentzen & Wettre tensile tester. For this purpose, samples of the synthetic resin layer are cut to 50 mm width and 120 mm length. The gauge length is set to 100 mm. The gauge speed is 100 mm/min. The thickness and weight per unit area of the samples are determined and entered into the “Elastic modulus” test program of the Lorentzen & Wettre tensile tester. The tensile strength test is then carried out on the samples. The elastic modulus is determined from the ratio between mechanical stress and strain in the linear region of the stress-strain diagram.

### Deep-Drawability

The assessment of deep-drawability and sealability was carried out on a deep-drawing machine of the type Tiromat 3000 from Alfa Laval. The films were formed at a deep-drawing temperature of 110° C., i.e., heating was carried out by contact with a heating plate which was temperature-controlled to 110° C. The sealing was carried out at a temperature of 140° C. for a time of 1.5 seconds. It was noted whether a heating plate imprint was visible on the film and whether the sealing against paper was sufficiently high so that the paper web could not inadvertently detach from the film.

1. A multilayer deep-drawable packaging material having an upper face and a lower face, comprising at least one first and one second paper layer and at least one polymer layer, wherein the at least one first and one second paper layer are connected to one another by the at least one polymer layer, characterized in that the at least one polymer layer contains at least one water-soluble thermoplastic polymer.

2. The multilayer deep-drawable packaging material according to claim 1, characterized in that the at least one first and second paper layer have a basis weight of 30 to 300 g/m², in particular of 60 to 250 g/m², particularly preferably of 100 to 220 g/m².

3. The multilayer deep-drawable packaging material according to claim 1 or 2, characterized in that the application weight (absolutely dry) of the at least one polymer layer is in the range from 15 to 50 g/m², in particular in the range from 10 to 30 g/m².

4. The multilayer deep-drawable packaging material according to any of the preceding claims, characterized in that the at least one water-soluble thermoplastic polymer has, in the pH range from 3 to 11 and at 20±5° C. and 1013.25 hPa, a water solubility of at least 25% (m/m) polymer in water.

5. The multilayer deep-drawable packaging material according to any of the preceding claims, characterized in that the at least one water-soluble thermoplastic polymer has a modulus of elasticity of at least 0.8 GPa.

6. The multilayer deep-drawable packaging material according to any of the preceding claims, characterized in that the at least one water-soluble thermoplastic polymer is a biopolymer, in particular a biopolymer selected from modified and natural biopolymers.

7. The multilayer deep-drawable packaging material according to claim 6, characterized in that the biopolymer is selected from the group consisting of polysaccharides, in particular thermoplastic starch (TPS), polylactides (PLAs), polyhydroxybutyrates (PHBs), lignin-based thermoplastic polymers, polyvinyl alcohols or ethylene vinyl acetate copolymers (EVOHs) based on renewable raw materials, and mixtures thereof.

8. The multilayer deep-drawable packaging material according to any of the preceding claims, characterized in that the packaging material has a recyclability of more than 13 scoring points, preferably more than 16 scoring points, determined in accordance with the method described in project number 530592 of the bifa Umweltinstitut with the project title “Recyclingfähigkeit von Verpackungen”.

9. The multilayer deep-drawable packaging material according to any of the preceding claims, characterized in that the proportion of paper in the packaging material is greater than 80 wt. %, preferably greater than 90 wt. %, particularly preferably greater than 95 wt. %, relative to the total weight of the packaging material.

10. The multilayer deep-drawable packaging material according to any of the preceding claims, characterized in that the oxygen permeation of the packaging material is not more than 15 cm³/m² in 24 hours, measured according to DIN 53380-3 at a temperature of 23° C., 50% relative humidity and an air pressure of 1 atm.

11. The multilayer deep-drawable packaging material according to any of the preceding claims, characterized in that the water vapor permeation of the packaging material is not more than 50 g/m² in 24 hours, measured according to EN ISO 15106-3 at a temperature of 23° C., 50% relative humidity and an air pressure of 1 atm.

12. A method for producing a multilayer deep-drawable packaging material, comprising the following steps:
(a) providing a first paper layer;
(b) applying a polymer layer to the first paper layer;
(c) connecting the first paper layer, with the polymer layer applied thereto, to a second paper layer such that the polymer layer is located between the first paper layer and the second paper layer,
or
(a′) providing a second paper layer;
(b′) applying a polymer layer to the second paper layer;
(c′) connecting the second paper layer, with the polymer layer applied thereto, to a first paper layer such that the polymer layer is located between the first paper layer and the second paper layer,
wherein the polymer layer in step (b) contains at least one water-soluble and thermoplastic polymer.

13. The method for producing a multilayer deep-drawable packaging material according to claim 12, wherein before or after step (a) or during or after step (b) or after step (c) or before or during step (c′) another polymer layer is applied to the upper face of the first paper layer, which, in later usage, has contact with the product to be packaged, comprising at least one water-soluble thermoplastic polymer selected from PVOH, EVOH and mixtures thereof.

14. The method for producing a multilayer deep-drawable packaging material according to any of claims 12 and 13, wherein before or after step (c) or before step (a′) or after step (c′), printing is carried out on the lower face of the second paper layer, which, in later usage, forms the visible face of the packaging.

15. A use of the multilayer deep-drawable packaging material according to any of claims 1 to 11 for producing packaging, in particular food packaging.
